(19) United States
(12) Patent Application Publication
(10) Pub. No.: US 2012/0166672 A1
(43) Pub. Date: Jun. 28, 2012

(54) PATH COMPUTATION APPARATUS AND PATH COMPUTATION METHOD FOR THE SAME

(75) Inventor: Byeong-Sik KIM, Daejeon-si (KR)

(73) Assignee: Electronics and Telecommunications Research Institute, Daejeon-si (KR)

(21) Appl. No.: 13/297,878

(22) Filed: Nov. 16, 2011

(30) Foreign Application Priority Data
Dec. 22, 2010 (KR) 10-2010-0132726

(51) Int. Cl. G06F 15/173; G06F 17/30

(52) U.S. Cl. 709/238; 707/812; 707/E17.005

(57) ABSTRACT

Provided is a path computation apparatus capable of computing a path over a plurality of domain, and a path computation method for the path computation apparatus.

The path computation apparatus includes a database to store information including an ID of a domain, an ID of the path computation apparatus, and an IP address of a communication apparatus; a database management unit to store the information including the ID of the domain, the ID of the path computation apparatus, and the IP address of the communication apparatus in the database, and to create an extended message including the information including the ID of the domain, the ID of the path computation apparatus, and the IP address of the communication apparatus; and a location advertisement transmission/reception unit to transmit the extended message.

### CROSS-REFERENCE TO RELATED APPLICATION

This application claims the benefit under 35 U.S.C. §119(a) of a Korean Patent Application No. 10-2010-0132726, filed on Dec. 22, 2010, the entire disclosure of which is incorporated herein by reference for all purposes.

### BACKGROUND

1. Field

The following description relates to a path computation apparatus and a path computation method for the same, and more particularly, to a path computation apparatus capable of computing a path over a plurality of domains, and a path computation method for the path computation apparatus.

2. Description of the Related Art

In general, a network includes a plurality of domains, and in each domain, a plurality of communication apparatuses are connected to each other through a predetermined topology. Each communication apparatus communicates with other communication apparatuses in the same domain or in other domains. In order to allow a communication apparatus to communicate with another communication apparatus, a process of performing path computation to select a proper path is needed.

In particular, a method of performing path computation using a plurality of path computation elements (PCE) to establish a path was standardized by the IETF (Internet Engineering Task Force).

However, there were still difficulties in detecting the location of a path computation apparatus for a domain to which a destination communication apparatus belongs, which makes establishment of an optimized path difficult.

### SUMMARY

The following description relates to a path computation apparatus capable of computing a path over a plurality of domains by using information about the location of another path computation apparatus for a domain to which a destination communication apparatus belongs, and a path computation method for the path computation apparatus.

In one general aspect, there is provided a path computation apparatus including: a database to store information including an ID of a domain, an ID of the path computation apparatus, and an IP address of a communication apparatus; a database management unit to store the information including the ID of the domain, the ID of the path computation apparatus, and the IP address of the communication apparatus in the database, and to create an extended message including the information including the ID of the domain, the ID of the path computation apparatus, and the IP address of the communication apparatus; and a location advertisement transmission/reception unit to transmit the extended message.

The path computation apparatus further includes a location information collector to control the database management unit to store the information including the IP address of the communication apparatus which exists in the domain, in the database.

The path computation apparatus further includes an ID allocator to transmit the ID of the domain and the ID of the path computation apparatus to the database management unit so as for the database management unit to store the ID of the domain and the ID of the path computation apparatus in the database.

The location information collector collects information including IP addresses of communication apparatuses which exist in the domain, using one protocol selected from among SNMP, OSPE, and ISIS protocols.

In another general aspect, there is provided a communication system including: at least two domains to which a plurality of communication apparatuses are connected; and at least two path computation apparatuses connected to the at least two domains, respectively, to compute a path between the plurality of communication apparatuses, wherein each path computation apparatus includes a database to store information including an ID of a corresponding domain, an ID of the path computation apparatus, and an IP address of a communication apparatus; a database management unit to store the information including the ID of the domain, the ID of the path computation apparatus, and the IP address of the communication apparatus in the database, and to create an extended message including the information including the ID of the domain, the ID of the path computation apparatus, and the IP address of the communication apparatus; and a location advertisement transmission/reception unit to transmit the extended message.

A location advertisement transmission/reception unit of a path computation apparatus connected to one of the at least two domains transmits a message including an ID of the domain, an ID of the path computation apparatus, and an IP address of a communication apparatus, to another path computation apparatus connected to the other domain.

The path computation apparatus connected to the domain requests a path of communication apparatuses belonging to the other domain, to another path computation apparatus connected to the other domain.

The communication system further includes an ID allocator to transmit the ID of the domain and the ID of the path computation apparatus to the database management unit so as for the database management unit to store the ID of the domain and the ID of the path computation apparatus in the database.

The communication system further includes a location information collector to control the database management unit to store information including IP addresses of communication apparatuses which exist in the domain, in the database.

The number of the path computation apparatuses is less than the number of the domains.

In another general aspect, there is provided a path computation method including: receiving, in a network including a first domain and a second domain, a request for establishing a path from a first communication apparatus belonging to the first domain to a second communication apparatus belonging to the second domain; identifying, when receiving the request for establishing the path, a second path computation apparatus connected to the second domain, and requesting the second path computation apparatus to compute a path of communication apparatuses in the second domain; receiving information regarding the path of the communication apparatuses in the second domain, from the second path computation apparatus; and reflecting the information about the path of the communication apparatuses in the second domain to detect a path of communication apparatuses in the first domain, thus establishing the path from the first communication apparatus to the second communication apparatus.

The receiving of the information regarding the path of the communication apparatuses in the second domain further includes transmitting, when a third domain is connected between the first domain and the second domain, the information regarding the path of the communication apparatuses in the second domain to a third path computation apparatus connected to the third domain, allowing the third path computation apparatus to reflect the information regarding the path of the communication apparatuses in the second domain to compute a path of communication apparatuses in the third domain, and transmitting information regarding the path of the communication apparatuses in the third domain to the first path computation apparatus.

The receiving of the request for establishing the path from the first communication apparatus to the second communication apparatus further includes allowing a plurality of path computation apparatuses connected to the network and including the first and second path computation apparatuses to transmit/receive a message including IDs of the path computation apparatuses, IDs of domains to which the path computation apparatuses belong, and IP addresses of the communication apparatuses, and to store the IDs of the path computation apparatuses, the IDs of the domains, and the IP addresses of the communication apparatuses.

The receiving of the request for establishing the path from the first communication apparatus to the second communication apparatus further includes allowing a plurality of path computation apparatuses connected to the network and including the first and second path computation apparatuses to collect information about communication apparatuses connected to each domain.

Therefore, according to the path computation apparatus and method, by detecting the location of a path computation apparatus for a domain to which a destination communication apparatus belongs, a path to an arbitrary communication apparatus in any domain may be computed. Specifically, since the location of a path computation apparatus for a destination domain is detected using an extended communication protocol, there is no need for development of an additional communication system for path computation.

Other features and aspects will be apparent from the following detailed description, the drawings, and the claims.

### BRIEF DESCRIPTION OF THE DRAWINGS

FIG. 1 illustrates an example of a network including a plurality of path computation apparatuses.

FIG. 2 shows an example of a message that is used by the path computation apparatuses illustrated in FIG. 1.

FIG. 3 is a diagram illustrating an example of a path computation apparatus illustrated in FIG. 1.

FIG. 4 is a flowchart illustrating an example of a method in which a path computation apparatus illustrated in FIG. 1 computes a path.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

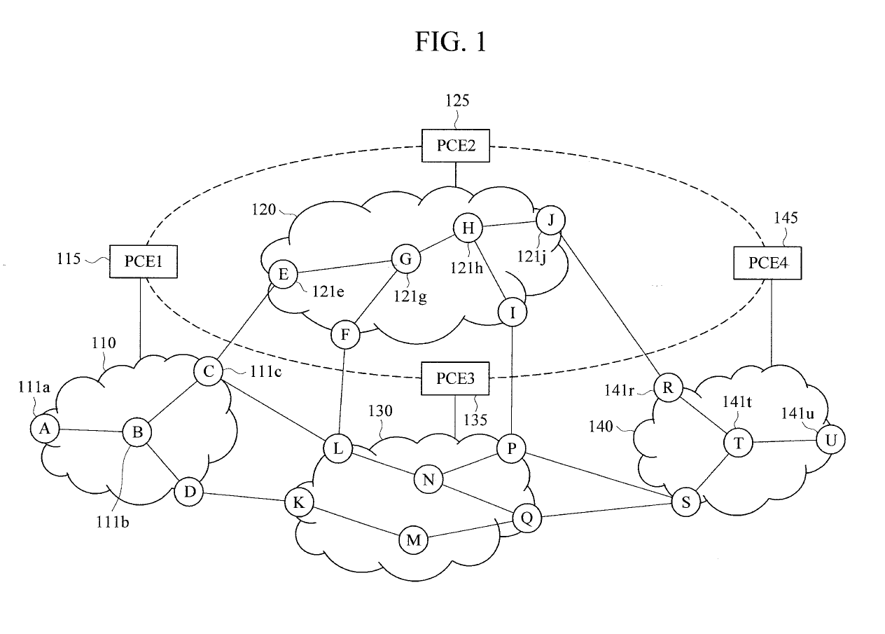

FIG. 1 illustrates an example of a network including a plurality of path computation apparatuses.

Referring to FIG. 1, the network includes first through fourth domains 110, 120, 130, and 140, and first through fourth path computation apparatuses PCE1 through PCE4 115, 125, 135, and 145 that are respectively connected to the first through fourth domains 110, 120, 130, and 140.

The first through fourth domains 110, 120, 130, and 140 include a plurality of communication apparatuses A through U 111a, 111b, . . . , 141t, 141u having routers. The communication apparatuses A through U 111a, 111b, . . . , 141t, 141u are connected to each other through individual paths that are established according to a predetermined communication protocol.

The first through fourth path computation apparatuses PCE1 through PCE4 115, 125, 135, and 145 compute a path from a communication apparatus in the corresponding domain to another communication apparatus in another domain to determine an optimal path therebetween. For example, The first through fourth path computation apparatuses PCE1 through PCE4 115, 125, 135, and 145 allow the communication apparatus A 111a to communicate with the communication apparatus U 141u through an optimal path. At this time, the first through fourth path computation apparatuses PCE1 through PCE4 115, 125, 135, and 145 collect the location information, connection relationship information, etc. of the communication apparatuses in the individual domains, wherein the communication apparatuses are connected to each other according to a predetermined communication protocol, such as SNMP, OSPE, ISIS, or the like.

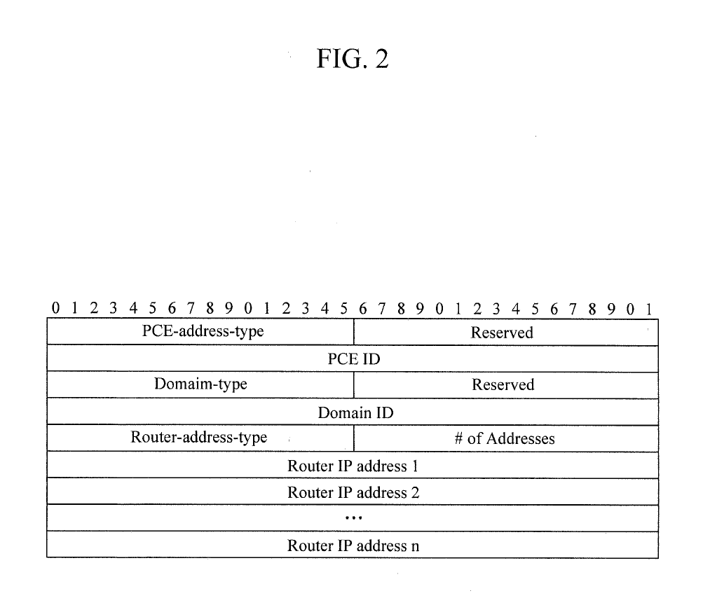

FIG. 2 shows an example of a message that is used by the first through fourth path computation apparatuses PCE1 through PCE4 115, 125, 135, and 145 illustrated in FIG. 1.

Referring to FIGS. 1 and 2, the first through fourth path computation apparatuses PCE1 through PCE4 115, 125, 135, and 145 each extends a LSA protocol used as an IGP communication protocol to create a LSA message (see FIG. 2) including an ID of the corresponding path computation apparatus, an ID of a domain to which the path computation apparatus belongs, Internet Protocol (IP) addresses of communication apparatuses that use the path computation apparatus, etc., and communicates with other path computation apparatuses to share the LSA message with all path computation apparatuses connected to a network. That is, each path computation apparatus shares its own ID, an ID of a domain to which the path computation apparatus belongs, IP addresses of communication apparatuses that use the path computation apparatus, with other path computation apparatuses.

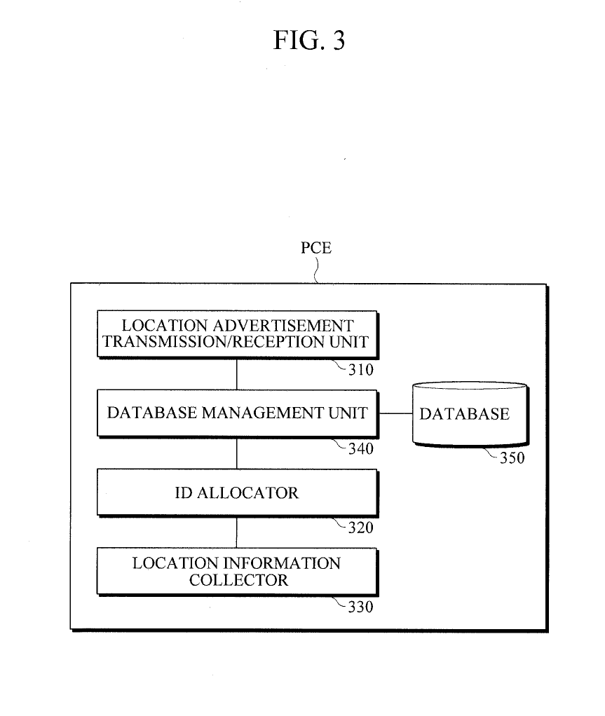

FIG. 3 is a diagram illustrating an example of one of the first through fourth path computation apparatuses PCE1 through PCE4 115, 125, 135, and 145 as illustrated in FIG. 1.

Referring to FIG. 3, a path computation apparatus PCE includes a location advertisement transmission/reception unit 310, an ID allocator 320, a location information collector 330, a database management unit 340, and a database 350.

The location advertisement transmission/reception unit 310 receives/transmits an extended LSA message from/to another path computation apparatus, thereby sharing an ID of the path computation apparatus PCE, an ID of a domain to which the path computation apparatus PCE belongs, IP addresses of communication apparatuses that use the path computation apparatus PCE, etc. with the other path computation apparatus PCE. The reason of sharing the domain ID with the other path computation apparatus is because there is the case where a path computation apparatus which is connected to a plurality of domains computes a path over the plurality of domains.

The ID allocator 320 transmits the ID of the domain to which the communication apparatuses belong, and the ID of the path computation apparatus PCE, to the database management unit 340.

The location information collector 330 collects location information of the communication apparatuses located in the domain to which the path computation apparatus PCE belongs, using a predetermined communication protocol, such as SNMP, OSPF, ISIS, or the like.

The database management unit 340 stores information collected by the location advertisement transmission/reception unit 310, the ID allocator 320, the location information collector 330, etc., in the database 350, creates a message using the information stored in the database 350, and then transmits the message through the location advertisement transmission/reception unit 310.

Then, the database 350 provides the stored information to the database management unit 340 so as for the database management unit to create an extended LSA message.

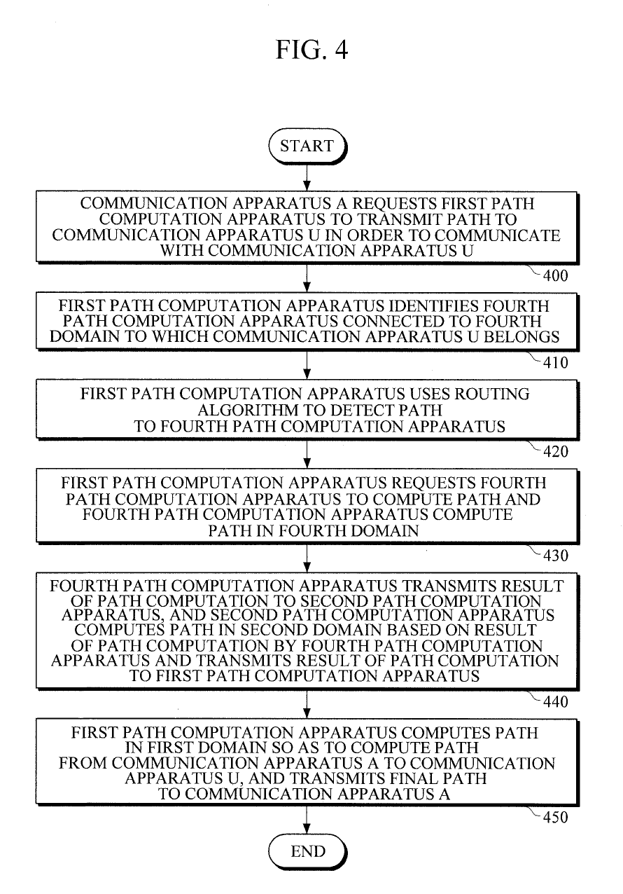

FIG. 4 is a flowchart illustrating an example of a method in which a path computation apparatus (for example, PCE1 115) illustrated in FIG. 1 computes a path.

Referring to FIGS. 1 and 4, the communication apparatus A 111a requests the first path computation apparatus PCE1 115 to transmit a path to the communication apparatus U 141u belonging to the fourth domain 140 that is different from the first domain 110 in order to communicate with the communication apparatus U 141u (400).

Then, the first path computation apparatus PCE1 115 identifies the fourth path computation apparatus PCE4 145 for computing a path for the fourth domain 140 to which the communication apparatus U 141u belongs (410). At this time, the first path computation apparatus PCE1 115 shares IDs of other path computation apparatuses for other domains, IDs of the other domains, etc. through an extended LSA message. Accordingly, the first path computation apparatus PCE1 115 may identify the fourth path computation apparatus PCE4 145 for the fourth domain 140 to which the communication apparatus U 141u belongs, using the IDs of the path computation apparatuses and the IDs of the domains.

Then, the first path computation apparatus PCE1 115 uses a predetermined routing algorithm to detect a path from the first path computation apparatus PCE1 115 to the fourth path computation apparatus PCE4 145 via the second path computation apparatus PCE2 125 (420). Then, the first path computation apparatus PCE1 115 uses a predetermined protocol such as a Path Computation Element Protocol (PCEP) to request the fourth path computation apparatus PCE4 145 to compute a path (for example, a path of the communication apparatus R 141r->the communication apparatus T 141t->the communication apparatus U 141u) to the communication apparatus U 141u in the fourth domain 140. When receiving the request for path computation from the first path computation apparatus PCE1 115, the fourth path computation apparatus PCE4 145 computes a path of communication apparatuses in the fourth domain 140 to which the fourth path computation apparatus PCE4 145 is connected (430). After computing the path, the fourth path computation apparatus PCE4 145 transmits the result of the path computation to the second path computation apparatus PCE2 125. Then, the second path computation apparatus PCE2 125 receives the result of the path computation from the fourth path computation apparatus PCE4 145, and reflects the result of the path computation by the fourth path computation apparatus PCE4 145 to compute a path (for example, a path of the communication apparatus E 121e->the communication apparatus G 121g->the communication apparatus H 121h->the communication apparatus J 121j) of the communication apparatuses in the second domain 120 to which the second path computation apparatus 125 is connected. After the path computation is complete, the second path computation apparatus PCE2 125 transmits the result of the path computation to the first path computation apparatus PCE1 115 (440). Then, the first path computation apparatus PCE1 115 reflects the result of the path computation by the second path computation apparatus 125 to compute a path (for example, a path of the communication apparatus A 111a->the communication apparatus B 111b->the communication apparatus C 111c) of the communication apparatuses in the first domain A to which the first path computation apparatus PCA1 115 is connected, and transmits the final result of the path computation to the communication apparatus A 111a (450).

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A path computation apparatus comprising:
a database to store information including an ID of a domain, an ID of the path computation apparatus, and an IP address of a communication apparatus;
a database management unit to store the information including the ID of the domain, the ID of the path computation apparatus, and the IP address of the communication apparatus in the database, and to create an extended message including the information including the ID of the domain, the ID of the path computation apparatus, and the IP address of the communication apparatus; and
a location advertisement transmission/reception unit to transmit the extended message.

2. The path computation apparatus of claim 1, further comprising a location information collector to control the database management unit to store the information including the IP address of the communication apparatus which exists in the domain, in the database.

3. The path computation apparatus of claim 2, further comprising an ID allocator to transmit the ID of the domain and the ID of the path computation apparatus to the database management unit so as for the database management unit to store the ID of the domain and the ID of the path computation apparatus in the database.

4. The path computation apparatus of claim 2, wherein the location information collector collects information including IP addresses of communication apparatuses which exist in the domain, using one protocol selected from among SNMP, OSPE, and ISIS protocols.

5. A communication system comprising:
at least two domains to which a plurality of communication apparatuses are connected; and
at least two path computation apparatuses connected to the at least two domains, respectively, to compute a path between the plurality of communication apparatuses,
wherein each path computation apparatus comprises
a database to store information including an ID of a corresponding domain, an ID of the path computation apparatus, and an IP address of a communication apparatus;
a database management unit to store the information including the ID of the domain, the ID of the path computation apparatus, and the IP address of the communication apparatus in the database, and to create an extended message including the information including the ID of the domain, the ID of the path computation apparatus, and the IP address of the communication apparatus; and
a location advertisement transmission/reception unit to transmit the extended message.

6. The communication system of claim 5, wherein a location advertisement transmission/reception unit of a path computation apparatus connected to one of the at least two domains transmits a message including an ID of the domain, an ID of the path computation apparatus, and an IP address of a communication apparatus, to another path computation apparatus connected to the other domain.

7. The communication system of claim 5, wherein the path computation apparatus connected to the domain requests a path of communication apparatuses belonging to the other domain, to another path computation apparatus connected to the other domain.

8. The communication system of claim 5, further comprising an ID allocator to transmit the ID of the domain and the ID of the path computation apparatus to the database management unit so as for the database management unit to store the ID of the domain and the ID of the path computation apparatus in the database.

9. The communication system of claim 5, further comprising a location information collector to control the database management unit to store information including IP addresses of communication apparatuses which exist in the domain, in the database.

10. The communication system of claim 9, wherein the number of the path computation apparatuses is less than the number of the domains.

11. A path computation method comprising:
receiving, in a network including a first domain and a second domain, a request for establishing a path from a first communication apparatus belonging to the first domain to a second communication apparatus belonging to the second domain;
identifying, when receiving the request for establishing the path, a second path computation apparatus connected to the second domain, and requesting the second path computation apparatus to compute a path of communication apparatuses in the second domain;
receiving information regarding the path of the communication apparatuses in the second domain, from the second path computation apparatus; and
reflecting the information about the path of the communication apparatuses in the second domain to detect a path of communication apparatuses in the first domain, thus establishing the path from the first communication apparatus to the second communication apparatus.

12. The path computation method of claim 11, wherein the receiving of the information regarding the path of the communication apparatuses in the second domain further comprises transmitting, when a third domain is connected between the first domain and the second domain, the information regarding the path of the communication apparatuses in the second domain to a third path computation apparatus connected to the third domain, allowing the third path computation apparatus to reflect the information regarding the path of the communication apparatuses in the second domain to compute a path of communication apparatuses in the third domain, and transmitting information regarding the path of the communication apparatuses in the third domain to the first path computation apparatus.

13. The path computation method of claim 11, wherein the receiving of the request for establishing the path from the first communication apparatus to the second communication apparatus further comprises allowing a plurality of path computation apparatuses connected to the network and including the first and second path computation apparatuses to transmit/receive a message including IDs of the path computation apparatuses, IDs of domains to which the path computation apparatuses belong, and IP addresses of the communication apparatuses, and to store the IDs of the path computation apparatuses, the IDs of the domains, and the IP addresses of the communication apparatuses.

14. The path computation method of claim 11, wherein the receiving of the request for establishing the path from the first communication apparatus to the second communication apparatus further comprises allowing a plurality of path computation apparatuses connected to the network and including the first and second path computation apparatuses to collect information about communication apparatuses connected to each domain.
